(19) United States
(12) Patent Application Publication
(10) Pub. No.: US 2022/0004998 A1
(43) Pub. Date: Jan. 6, 2022

(54) Client Management Systems And Methods

(71) Applicant: Brown Bunny LLC, San Francisco, CA (US)

(72) Inventors: James Zhang, San Francisco, CA (US); Nerissa Zhang, San Francisco, CA (US); Sergey Varlamov, Icic (HR)

(21) Appl. No.: 16/918,761

(22) Filed: Jul. 1, 2020

(51) Int. Cl. G06Q 10/10; G06Q 10/02; G06Q 30/06

(52) U.S. Cl. CPC G06Q 10/1095; G06Q 30/0603; G06Q 10/02

(57) ABSTRACT

Example client management systems and methods are described. In one implementation, a client management system identifies a client of a trainer and determines a scheduling rule associated with the client. The scheduling rule defines a regular schedule for the client's training sessions with the trainer. The client management system receives, from the client, a request to cancel a training session scheduled with the trainer. The client management system reschedules the training session by canceling the training session and scheduling a new training session based on the scheduling rule.

### TECHNICAL FIELD

The present disclosure relates to systems and methods for managing clients and client-related activities.

### BACKGROUND

Personal trainers and other people who work with individual clients spend significant amounts of time managing the relationship with their clients. For example, personal trainers communicate with their clients regarding payment, scheduling, canceling training sessions, rescheduling training sessions, and more. Frequently, these personal trainers use multiple computer software applications to accomplish billing, scheduling, and rescheduling sessions. If these computer software applications don't communicate with each other, it becomes tedious for the personal trainer to copy data between applications and regularly monitor all of the software applications used to run their business.

Many personal trainers sell packages of training sessions (e.g., a 10 session package). When training sessions are canceled or rescheduled, it is difficult to keep track of the number of unused training sessions in a particular package. Similarly, it is difficult to know when a particular client needs to purchase another package of training sessions.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an environment within which an example embodiment may be implemented.

FIG. 2 is a block diagram illustrating an embodiment of a client management system.

FIG. 3 is a flow diagram illustrating an embodiment of a method for setting up a new client and automatically scheduling the client's first group of training sessions.

FIG. 4 illustrates an embodiment of a client schedule created based on a scheduling rule associated with the client.

FIG. 5 illustrates an embodiment of a graphical user interface (GUI) that allows a trainer to select a client to manage.

FIG. 6 illustrates an embodiment of a GUI that allows a trainer to create a group of sessions for a client.

FIG. 7 illustrates an embodiment of a GUI that allows a trainer to define a scheduling rule associated with the client.

FIG. 8 illustrates an embodiment of a GUI that allows a client to purchase a group of training sessions.

FIG. 9 illustrates an embodiment of a GUI that displays the number of training sessions used and the number of training sessions remaining in a group of purchased training sessions.

FIG. 10 is a flow diagram illustrating an embodiment of a method for automatically rescheduling a canceled training session based on the scheduling rule associated with the client.

FIG. 11 illustrates an embodiment of an updated client schedule showing the canceled training session and the new training session.

FIG. 12 illustrates an embodiment of a GUI that displays session cancellation information to a client.

FIG. 13 is a flow diagram illustrating an embodiment of a method for automatically handling renewal payments and scheduling new sessions upon payment.

FIG. 14 illustrates an embodiment of a GUI that displays a cancelled training session and a button that allows a user to manually reschedule a training session.

FIG. 15 illustrates an embodiment of a GUI that displays a calendar with open sessions to manually reschedule a canceled training session.

FIG. 16 illustrates an embodiment of a GUI that displays a canceled training session and a suggested make-up training session to the client.

FIG. 17 illustrates an embodiment of a GUI that displays a canceled training session and a suggested make-up training session to the trainer and provides an option for the trainer to accept or decline the suggested make-up training session.

FIG. 18 illustrates an embodiment of a GUI that displays an accepted make-up training session to the trainer.

FIG. 19 illustrates an embodiment of a GUI that displays a gym membership request sent by a trainer or gym manager to a customer.

FIG. 20 illustrates an embodiment of a GUI that displays a warning to the client that they may forfeit the training session because the client is cancelling less than 24 hours before the training session.

FIG. 21 illustrates an embodiment of a GUI that displays a message to the trainer allowing the trainer to forfeit the training session or suggest a make-up training session.

FIG. 22 is a block diagram illustrating an example computing device suitable for implementing the systems and methods described herein

### DETAILED DESCRIPTION

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

At least some embodiments of the disclosure are directed to computer program products comprising such logic (e.g., in the form of software) stored on any computer useable medium. Such software, when executed in one or more data processing devices, causes a device to operate as described herein.

Various examples discussed herein refer to personal trainers and their training clients. However, the described systems and methods are applicable to any type of business relationship (or personal relationship) that can benefit from the various management and scheduling techniques discussed herein.

The systems and methods described herein allow personal trainers and others to easily manage their clients and get paid quickly. The automated systems and processes discussed below save significant time (for both the trainer and the clients) by simplifying and automating many of the day-to-day activities. The described systems and methods provide a unified system that covers billing, scheduling, canceling training sessions, rescheduling training sessions, and generating reminders for clients to purchase a new package of training sessions. Thus, the single system described herein replaces multiple separate systems previously used for billing, scheduling, payment reminders, appointment reminders, renewal reminders, and the like. This system streamlines the administrative tasks required by a trainer, gym owner, or other individual and frees up time to focus on client training activities.

Clients, especially recurring clients, often buy training sessions in packs of 10, 20, or more, which may span several months. In many situations, there are cancellations due to vacations, work, and sickness. Personal trainers will either need to meticulously track these as they happen which is time consuming or make an educated guess based on memory which is error prone. Getting the session count wrong will either result in the trainer working for free (under count) or the client feeling the trainer is cheating them (over count). The more clients a trainer has, the worse this problem becomes. The described systems and methods provide a solution to this problem by automatically tracking the number of training sessions remaining for each client.

As mentioned above, cancellations and reschedules of personal training sessions happen with regularity. Today, this is often handled via text messages which is time consuming and distracting. Handling all training session cancellations and rescheduling via text messages wastes a significant amount of time and takes the trainer away from their important activity of training people. The systems and methods discussed herein automate the process of canceling and rescheduling training sessions. In many situations, canceling and rescheduling is accomplished without any input from the trainer.

Today, personal trainers can get paid using various methods or services, such as Venmo, Zelle, Check, Square, etc. These methods and services do not enforce timely payment by the client. The burden is on the trainer to enforce payment deadlines and remind clients to pay. This may create financial hardship for the trainer and produces awkward social dynamics between clients and trainers. The more clients a trainer has, the worse this problem becomes.

The systems and methods described herein address these multiple problems and allow trainers to focus on training their clients instead of wasting time on tedious administrative tasks. The automation provided by the systems and methods saves significant time, increases trainer cash flow, and simplifies management of the trainer's schedule.

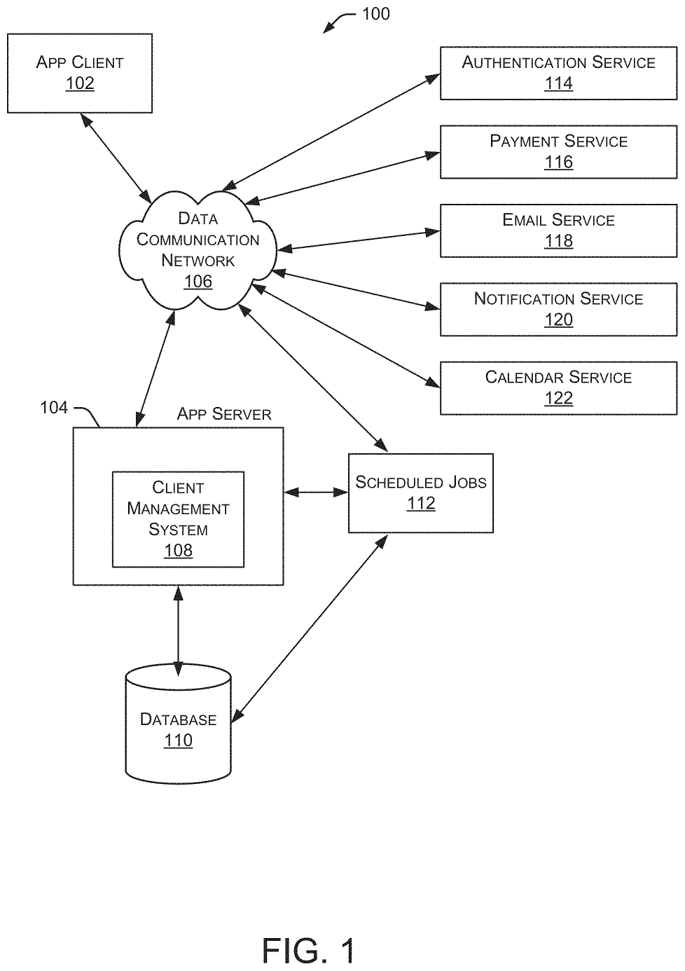

FIG. 1 is a block diagram illustrating an environment 100 within which an example embodiment may be implemented. As shown in FIG. 1, an app (application) client 102 is coupled to an app server 104 via a data communication network 106. In some embodiments, app client 102 executes on a mobile computing device, such as a mobile computing device operated by a user (e.g., a client or a trainer). In various implementations, the user may be referred to herein as a client, an instructor, a trainer, a coach, an owner, a manager, and the like. The mobile computing device executing app client 102 can be any type of computing device, such as a smartphone, a tablet, a wearable device, a laptop computer, a desktop computer, and the like.

App server 104 includes any type of computing device capable of operating as a server or other system capable of performing the functions discussed herein. App server 104 supports (or implements) a client management system 108 that manages and implements different types of functions related to clients, trainers, and other users. As shown in FIG. 1, app server 104 is coupled to a database 110 that stores various data used to perform the described functions. Example data may include user data, trainer data, calendar/schedule data, payment data, membership data, instructor data, class data, and the like.

Data communication network 106 includes any type of network topology using any communication protocol. Additionally, data communication network 106 may include a combination of two or more communication networks. In some embodiments, data communication network 106 includes a cellular communication network, the Internet, a local area network, a wide area network, or any other communication network. In environment 100, data communication network 106 allows communication between app client 102, app server 104, scheduled jobs 112, one or more authentication services 114, one or more payment services 116, one or more email services 118, one or more notification services 120, and one or more calendar services 122.

In some embodiments, scheduled jobs 112 are processes that run periodically on app server 104 to enforce the timeliness of various actions. For example, when a trainer sends a payment and/or schedule request to a client, scheduled jobs 112 send reminder emails (or other message formats) at predetermined time intervals. Additionally, as discussed herein, if a client does not pay an invoice within 24 hours, scheduled jobs 112 may run and remove any scheduled sessions from the trainer's calendar due to non-payment of the invoice. This allows the trainer to schedule another client in those time slots that were being reserved for the non-paying client. Scheduled jobs 112 also detects, for example, when a few training sessions remain in a package of sessions and automatically sends out renewal reminders and renewal links to the appropriate clients. As shown in FIG. 1, scheduled jobs 112 is coupled to app server 104, database 110, and data communication network 106. In other embodiments, scheduled jobs 112 is contained within app server 104 and maintains the ability to communicate with database 110 and data communication network 106.

Authentication service 114 is used, for example, by client management system 108 to authenticate a client or other information. In some embodiments, authentication service 114 supports identity management, such as client authentication. For example authentication service 114 may use email and password data to authenticate a client seeking access to the systems and methods discussed herein. In some implementations, the email and password data is stored in authentication service 114 instead of database 110 for added security. In other embodiments, authentication service 114 may allow a client to access the systems and methods described herein using social media login credentials and the like.

Payment service 116 allows client management system 108 to collect payments from clients and distribute the payment to a trainer or entity. Email service 118 allows client management system 108 to coordinate the sending and receiving of emails with multiple client apps, client management system 108, and other services and systems. Notification service 120 generates various notifications for clients, trainers, and other users based on client management system 108 activities, such as scheduling sessions, paying for sessions, rescheduling sessions, and the like. Calendar service 122 manages various schedules, such as client schedules, trainer schedules, class schedules, instructor schedules, and the like. In some embodiments, client management system 108 uses calendar service 122 to, for example, manage trainer schedules, manage client sessions, and manage the rescheduling of sessions.

Although one app client 102 is shown in FIG. 1, a single client management system 108 can support any number of app clients 102 simultaneously.

It will be appreciated that the embodiment of FIG. 1 is given by way of example only. Other embodiments may include fewer or additional components without departing from the scope of the disclosure. Additionally, illustrated components may be combined or included within other components without limitation.

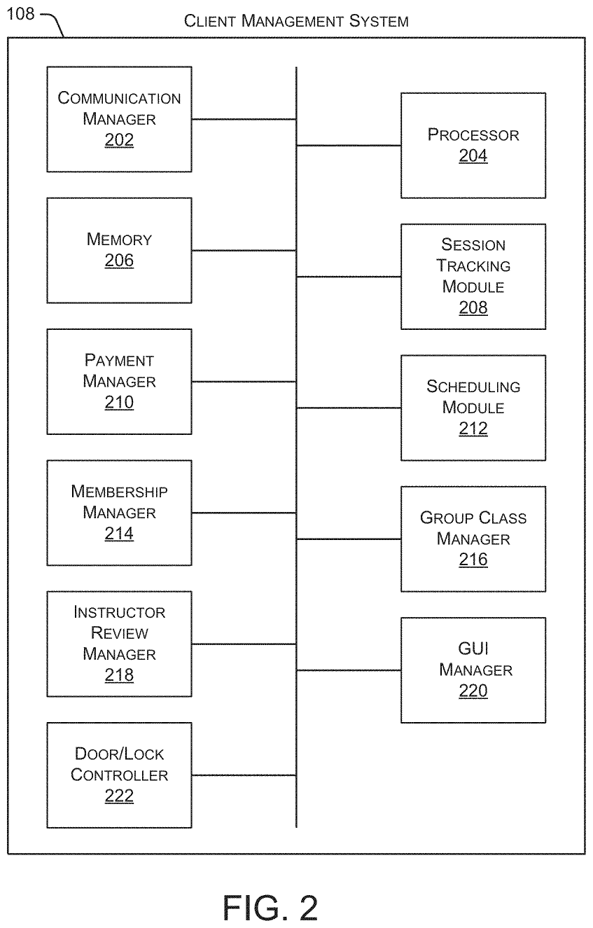

FIG. 2 is a block diagram illustrating an embodiment of client management system 108. As shown in FIG. 2, client management system 108 includes a communication manager 202, a processor 204, and a memory 206. Communication module 202 allows client management system 108 to communicate with other systems, such as multiple app clients 102, various services 114-122 shown in FIG. 1, and the like. Processor 204 executes various instructions to perform the functionality provided by client management system 108, as discussed herein. Memory 206 stores these instructions as well as other data used by processor 204 and other modules and components contained in client management system 108.

Additionally, client management system 108 includes a session tracking module 208 that manages various sessions (and groups of sessions) scheduled by clients, trainers, instructors, and others. A payment manager 210 is capable of generating (or initiating) invoices for sessions, classes, and other activities. Payment manager 210 also generates renewal reminders at appropriate times, overdue payment notices, and the like. In some embodiments, payment manager 210 communicates with payment service 116 to generate and issue invoices and other communications.

A scheduling module 212 manages schedules for trainers, clients, instructors, classes, and other users or activities. As discussed herein, scheduling module 212 also handles automatic rescheduling of sessions, reminder notifications of upcoming sessions, and the like. As discussed herein, scheduling module 212 may apply one or more scheduling rules to automatically schedule clients with trainers. In some embodiments, scheduling module 212 communicates with calendar service 122 to store and manage sessions, classes, and other activities. A membership manager 214 handles various types of memberships, such as gym memberships, training memberships, and class memberships.

Client management system 108 also includes a group class manager 216 that handles issues related to group classes. For example, group class manager 216 can manage group class schedules, class participants, class instructors, and so forth. In some embodiments, group class manager 216 manages class payments, manages class sign-ups by students, and generates class reminders and other notifications that are sent to class students, class instructors, and others. In some situations, group class manager 216 manages multiple instructors, multiple classes, and multiple students to maintain a steady class size, steady instructor workload, and the like. An instructor review manager 218 receives and stores reviews of instructors by class students, other instructors, and other individuals. Instructor review manager 218 may coordinate the distribution of reviews to appropriate instructors, supervisors of instructors, and others that desire access to the reviews.

Client management system 108 further includes a GUI manager 220 that manages, generates, and modifies various user interfaces, as discussed herein. These user interfaces allow clients, trainers, and others to schedule sessions, reschedule sessions, make payments, view scheduled sessions in a calendar, and the like. In some embodiments, GUI manager 220 is capable of modifying user interface information based on the type of device receiving and displaying the information.

Additionally, a door/lock controller 222 controls access to a door, door lock, storage cabinet, exercise room, exercise equipment, etc. associated with a gym, training studio, or other physical location. For example, door/lock controller 222 can restrict user access to particular doors, locations, and the like based on the user's permissions (e.g., membership level), time of day, availability of exercise rooms or exercise equipment, and so forth. If a user is not granted access, a message may be sent to the user indicating the reason for denying access, such as “no equipment available,” “exercise room is already at capacity,” or “your time to access the room/equipment has not yet started.”

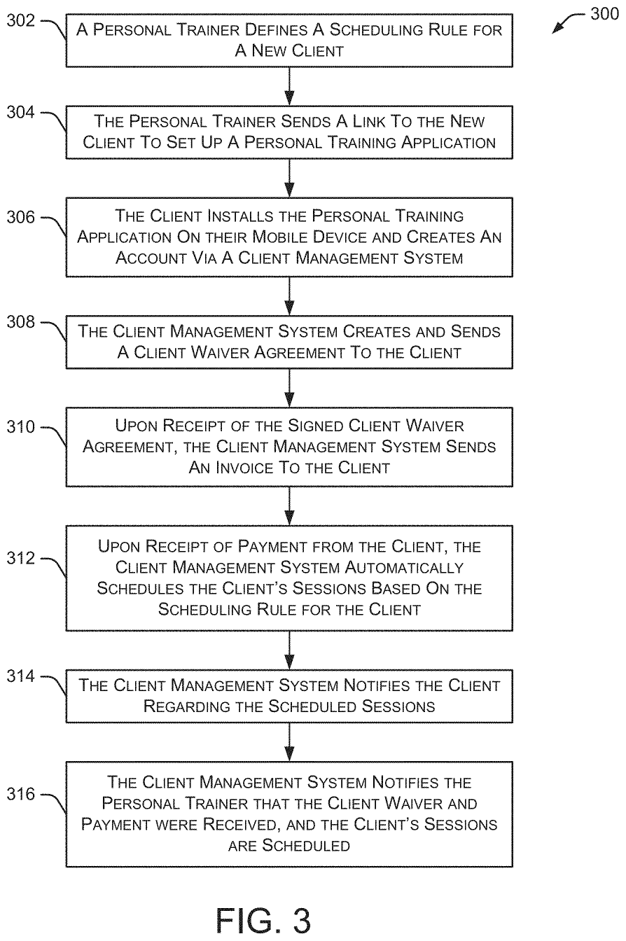

FIG. 3 is a flow diagram illustrating an embodiment of a method 300 for setting up a new client and automatically scheduling the client's first group of training sessions. Initially, a personal trainer defines 302 a scheduling rule for a new client. The scheduling rule identifies the new client's regular schedule for training sessions, such as “every Monday, Wednesday, and Friday 8:00-9:00 am” or “every Tuesday and Thursday 2:30-3:00 pm”. The scheduling rule is used to automatically schedule sessions for the client.

Method 300 continues as the personal trainer sends 304 a link to the new client to set up a personal training application on their mobile device. For example, the personal trainer may email or text the link to the new client. When the new client clicks on the link, they are taken to a location (e.g., website) to download and install the personal training application on their mobile device. The client installs 306 the personal training application on their mobile device and creates an account via a client management system (e.g., client management system 108).

The method continues as the client management system creates and sends 308 a waiver agreement to the client. In some embodiments, the client must sign and return the waiver agreement before the client is permitted to schedule sessions with the personal trainer. In other embodiments, the client can schedule sessions with the personal trainer, but the signed waiver agreement must be returned at least a particular time period (e.g., 3 days or 7 days) before the first scheduled session. Upon receipt of the signed waiver agreement, the client management sends 310 an invoice to the client. When payment is received from the client, the client management system automatically schedules 312 the client's sessions based on the scheduling rule for the client (i.e., the scheduling rule set at 302). Thus, the embodiment of FIG. 3 does not allow the client to schedule sessions with the personal trainer until the invoice is paid. In alternate embodiments, the client sessions with the personal trainer may be scheduled prior to paying the invoice, but those sessions are automatically canceled if the invoice is not paid within a specific time period (e.g., within 24 hours of scheduling the sessions).

After the client's sessions have been scheduled, the client management system notifies 314 the client regarding the dates and times of the sessions. This notification can be provided via email, text message, through the personal training application, or any other communication system. Additionally, the client management system notifies 316 the personal trainer that the client waiver and payment were received. The notification 316 also includes details regarding the client's sessions that were scheduled.

In some embodiments, then the trainer sends a link or request to the client, it may contain information related to the client's invoice. In this situation, the client management system may look up the invoice and present it to the client for payment. When the trainer sends the link or request to the client, the client management system automatically reserves the training session times based on the scheduling rule for the client. If the client does not pay the invoice within 24 hours (or any other time period specified by the trainer), scheduled jobs 112 will automatically remove the scheduled training sessions so the time slots can be scheduled for other clients.

Thus, the scheduling of client training sessions with a trainer is an asynchronous process. The client management system automates the scheduling process and eliminates nearly all calls, text messages, emails and other communications between trainers and clients just to reschedule a session. Additionally, by integrating the scheduling system and the payment system, the trainer knows that the client has paid for their package and does not need to send frequent payment reminders. If the client doesn't pay for the package of sessions within a particular period of time, the sessions are removed from the schedule so those time slots become available for the trainer to schedule other clients.

As mentioned above, membership manager 214 handles various types of memberships, such as gym memberships, training memberships, and class memberships. These memberships can be handled in a manner similar to the private training sessions discussed with respect to FIG. 3. For example, a trainer or gym manager sends a link or request for a client to pay for a membership, sign a waiver, etc. Scheduled jobs 112 will monitor these activities and expire the offer if payment is not completed within 24 hours or another defined time period. Each month, scheduled jobs 112 will automatically charge the client for the same amount based on their membership level. The client can cancel these automatic charges through the app.

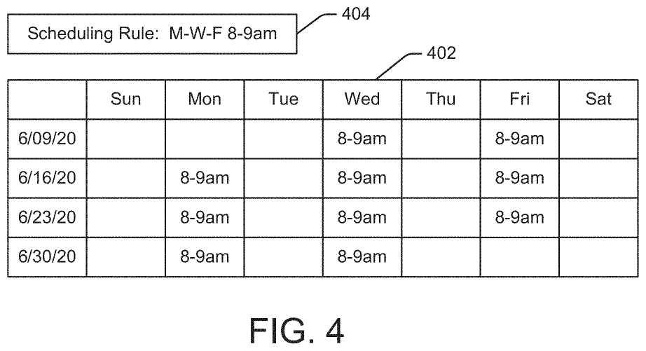

FIG. 4 illustrates an embodiment of a client schedule 402 created based on a scheduling rule associated with the client (e.g., the scheduling rule defined in 302 of FIG. 3). As shown in FIG. 4, a scheduling rule 404 for client schedule 402 is defined as having sessions every Monday, Wednesday, and Friday at 8:00-9:00 am. In this example, the client purchased a package of 10 training sessions. Based on the scheduling rule associated with the client, the 10 training sessions were automatically entered into the schedule. For example, the first session was entered on Wed. of week Jun. 9, 2020 and the remaining nine sessions were entered following the M-W-F 8-9 am rule, with the last of the 10 sessions being scheduled on Wed. of week Jun. 30, 2020.

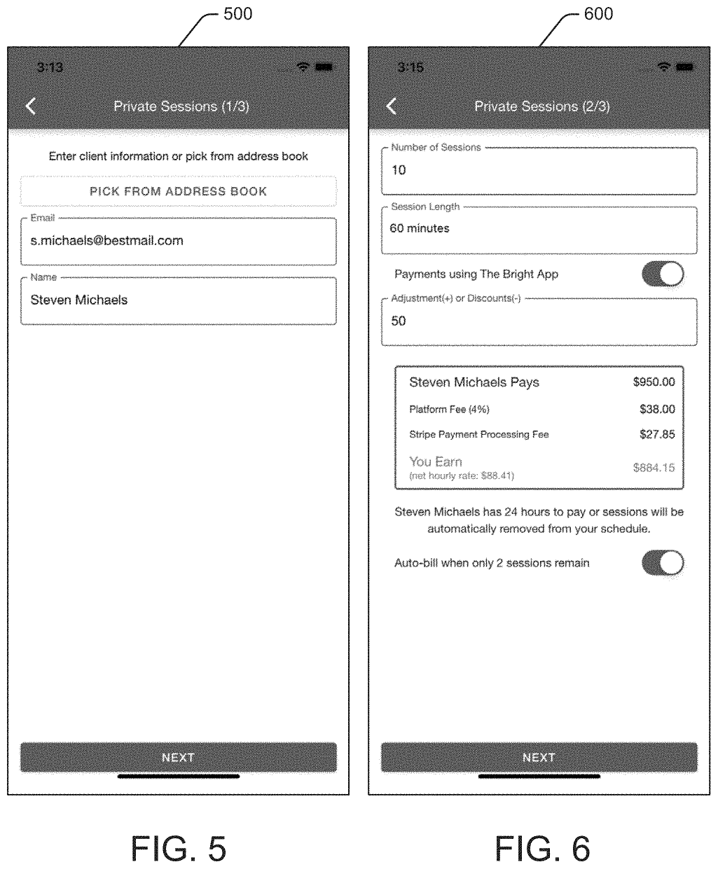

FIG. 5 illustrates an embodiment of a graphical user interface (GUI) 500 that allows a trainer to select a client to manage. For example, GUI 500 may be displayed to a personal trainer when setting up a new client or when accessing information associated with an existing client. All GUIs discussed herein and illustrated in the accompanying drawings may be displayed on any type of computing device, such as a smartphone, a tablet, a laptop computer, a desktop computer, a wearable device, and the like.

FIG. 6 illustrates an embodiment of a GUI 600 that allows a trainer to create a group of sessions for a client. In this example, the trainer can define the number of training sessions, the length of each training session, payment options, and any price adjustments. GUI 600 displays the data entered by the trainer as well as the costs and fees associated with the training sessions. GUI 600 also allows the trainer to automatically bill the client when only two training sessions remain. This automatic renewal of training sessions is described in greater detail below.

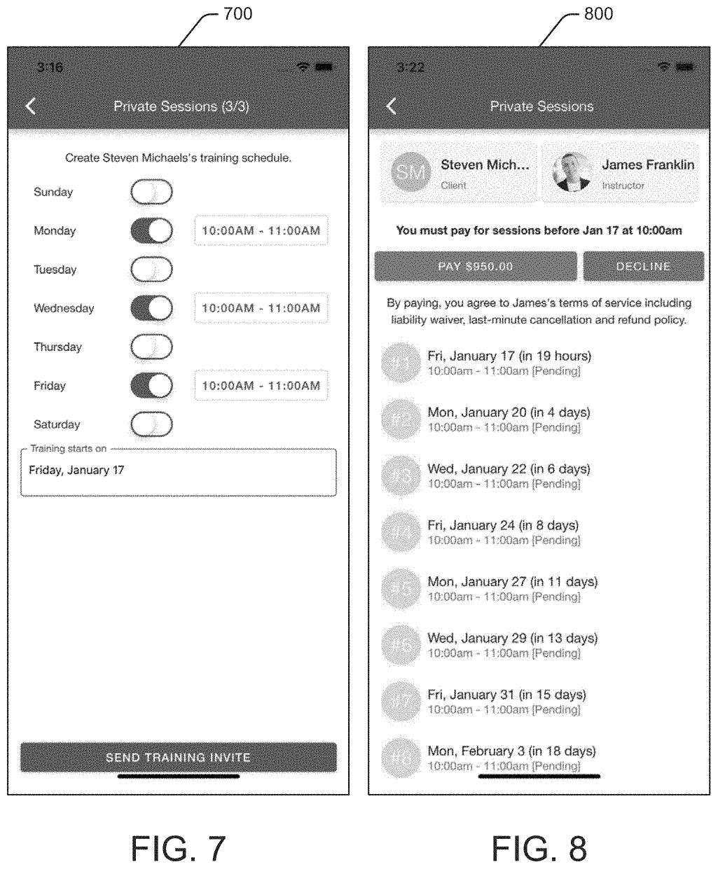

FIG. 7 illustrates an embodiment of a GUI 700 that allows a trainer to define a scheduling rule associated with the client. The scheduling rule was discussed above with respect to FIG. 3. As shown in GUI 700, slide buttons allow the user to select the days each week for training sessions. For each activated slide button, the user can select the time of the training session for that particular day of the week. The user can also set the start date for the scheduling rule to be applied. In some embodiments, the trainer defines the scheduling rule for each client. But, in some situations, a client may be granted access to set a new scheduling rule or modify an existing scheduling rule.

FIG. 8 illustrates an embodiment of a GUI 800 that allows a client to purchase a group of training sessions. GUI 800 includes a payment button and a decline button. GUI 800 also displays a listing of dates and times for the training sessions being purchased.

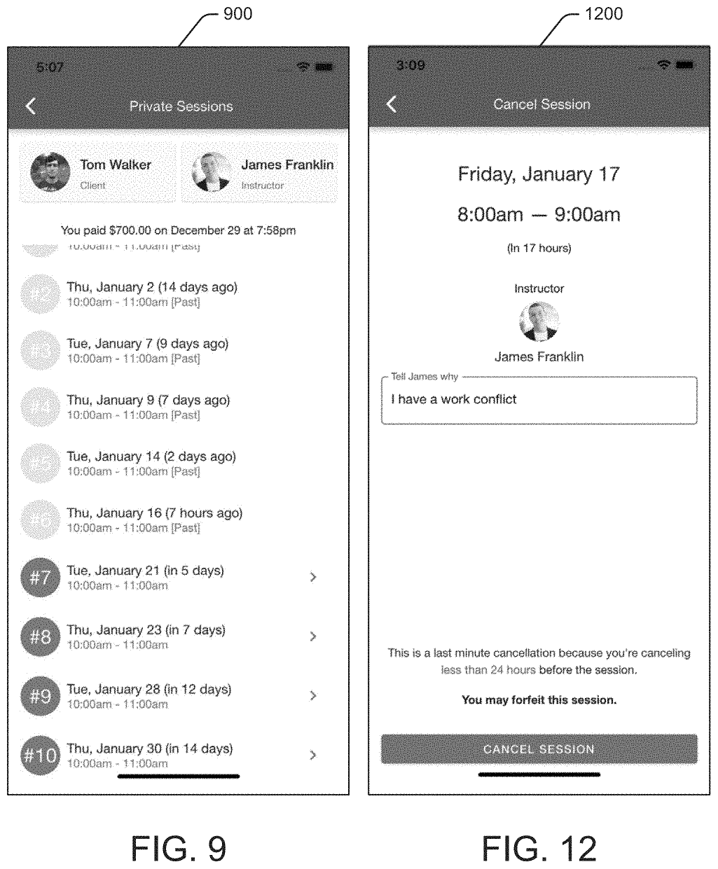

FIG. 9 illustrates an embodiment of a GUI 900 that displays the number of training sessions used and the number of training sessions remaining in a group of purchased training sessions. In the example of FIG. 9, GUI 900 displays 10 training sessions purchased by the user (#1-#10). As shown, six of the training sessions have been used. Those six training sessions are shown in a different color and GUI 800 indicates the date/time the training sessions were completed. The four remaining unused training sessions (#7-#10) are shown in a different color and indicate the scheduled date/time of the upcoming training sessions.

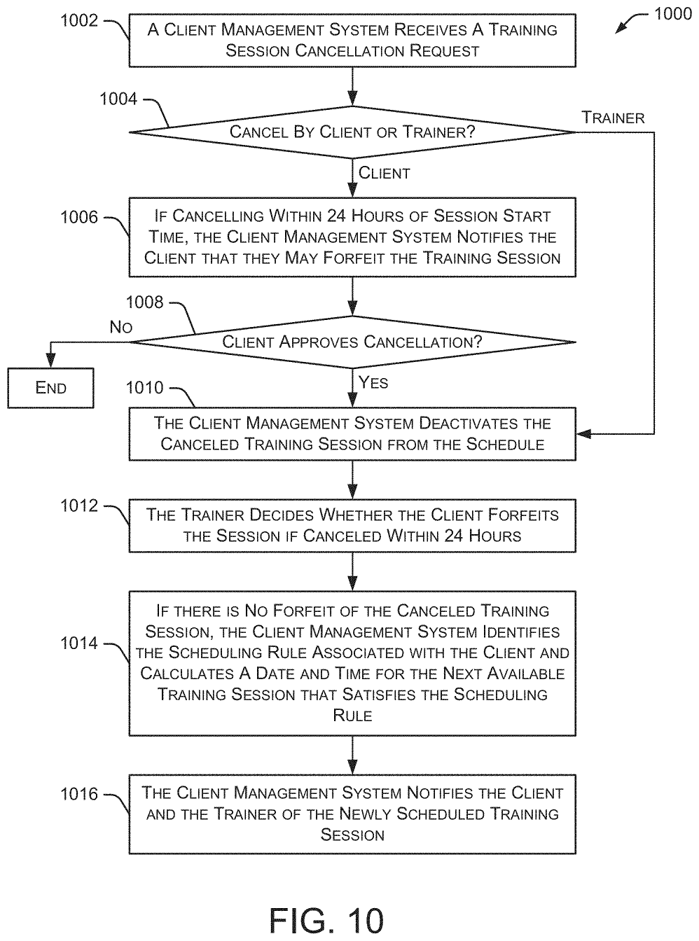

FIG. 10 is a flow diagram illustrating an embodiment of a method 1000 for automatically rescheduling a canceled training session based on the scheduling rule associated with the client. In some embodiments, the systems and methods discussed herein do not permit training sessions to be deleted. After training sessions have been scheduled and paid for, they can be canceled and rescheduled, but they cannot be deleted. This simplifies the tracking of the number of remaining training session each client has in their most recently purchased package of training sessions.

Initially, a client management system receives 1002 a training session cancellation request. For example, a client or a trainer may cancel an existing (i.e., previously scheduled) training session. Method 1000 takes different actions depending on whether the client canceled the training session or the trainer canceled the training session. In some embodiments, if clients don't cancel the training session within 24 hours of the session start time, they may forfeit the training session. However, there is typically no time restriction on when a trainer can cancel a training session. These rules regarding forfeiting training sessions can be set by each trainer depending on their own preferences and policies.

Method 1000 continues by determining 1004 whether the training session was canceled by the client or by the trainer. If the training session was canceled by the client, method 1000 determines 1006 whether the cancellation is within 24 hours of the session start time. If so, the client management system notifies 1006 the client that they may forfeit the training session, depending on the trainer's policies. If the client does not approve of the cancellation of the training session at 1008, method 1000 ends and the training session is not canceled. For example, the client may decide not to cancel the training session because they are worried that they will forfeit the training session.

If the client approves of the cancellation (or the training session was canceled by the trainer at 1004) then method 1000 continues as the client management system deactivates 1010 the canceled training session from the schedule. If the training session was canceled within 24 hours of the session start time, the trainer decides 1012 whether the client forfeits the training session. For example, the trainer may receive a message from the client management system notifying them of the “less than 24 hour cancellation” and asking if the trainer wants to allow the client to reschedule the training session or forfeit the training session.

If there is no forfeiture of the canceled training session, the client management system identifies 1014 the scheduling rule associated with the client and determines (e.g., calculates) a date and time for the next available training session that satisfies the scheduling rule. The client management system then notifies 1016 the client and the trainer of the newly scheduled training session. If the client forfeited the canceled training session, steps 1014 and 1016 are not necessary because the canceled training session is not rescheduled.

As discussed herein, canceled training sessions can be rescheduled automatically by calculating the next available time slot (e.g., date and time) in the calendar that satisfies the scheduling rule for the client. But, in some situations, the client or trainer may want to schedule the make-up training session manually (e.g., they are not happy with the automatically selected day/time for the new training session). In these situations, the client or trainer suggests a date/time for a make-up training session. The other party can accept or reject the suggested date/time for the make-up training session. If the suggested date/time is accepted, the training session is moved to the new date/time on the calendar. If the suggested date/time is rejected, the automatically scheduled time for the new training session stays on the calendar. In some implementations, a link or request is sent to the other party regarding the suggested date/time for the make-up training. This link may expire after a particular time period (e.g., 24 hours) which leaves the automatically scheduled training session on the calendar.

FIG. 11 illustrates an embodiment of an updated client schedule 1102 showing the canceled training session and the new training session. For this example, assume that FIG. 4 represents the schedule prior to cancelling the training session. A scheduling rule 1104 is the same as scheduling rule 404 shown in FIG. 4. As shown in FIG. 11, one training session 1106 is canceled. That entry in schedule 1102 is shown with a line through the time to indicate the canceled training session. In some embodiments, entry 1106 may be shown as a different color (e.g., red) to indicate a canceled training session. By applying the scheduling rule associated with the client, a new training session 1108 is automatically scheduled. The process illustrated in FIGS. 10 and 11 is performed automatically so that canceled training sessions can be automatically rescheduled without requiring any action by the trainer and without requiring any communication between the trainer and the client.

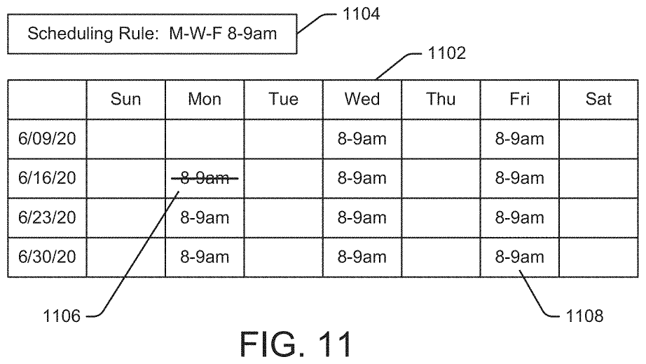

FIG. 12 illustrates an embodiment of a GUI 1200 that displays session cancellation information to a client. As shown in FIG. 12, the client canceling a training session can provide a reason for the cancellation. GUI 1200 may also display an indication to the client that they may forfeit the training session because they are canceling less than 24 hours before the session. GUI 1200 includes a button asking the client to confirm canceling the training session.

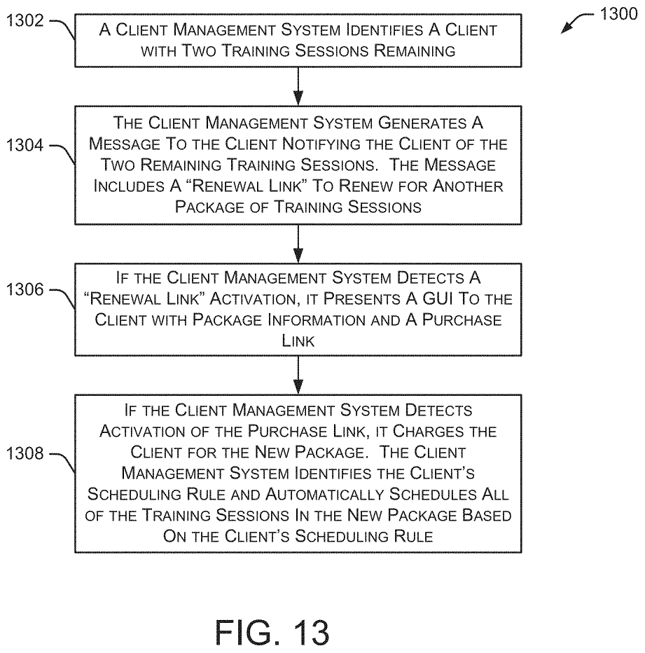

FIG. 13 is a flow diagram illustrating an embodiment of a method 1300 for automatically handling renewal payments and scheduling new sessions upon payment. Initially, a client management system identifies 1302 a client with two training sessions remaining. In other implementations, the client management system may identify clients with other amounts of training sessions remaining.

Method 1300 continues as the client management system generates a message to the identified client notifying 1304 the client of the two remaining training sessions. For example, the message may include a renewal link to renew for another package of training sessions. If the client management system detects 1306 a renewal link activation, it presents a GUI (or other information) to the client with package information and a purchase link. For example, the GUI may be similar to GUI 800 shown in FIG. 8. If the client management system detects 1308 activation of the purchase link, it charges the client for the new package. Additionally, the client management system identifies the client's scheduling rule and automatically schedules all of the training sessions in the new package based on the client's scheduling rule. Thus, the renewal, payment, and scheduling of a new package of training sessions occurs automatically with no input required from the trainer and minimal input required from the client.

In some embodiments, the systems and methods described herein support a marketplace for individual trainers, individual classes (e.g., group classes), training studios, and the like. The marketplace may provide profiles or summaries of individual trainers that describes, for example, their experience, areas of expertise, style of training, training certifications, geographic location, type of training studio, training fees, types of training packages, client testimonials, etc. Additionally, the marketplace may provide summaries and other information for individual classes, training studios, and the like. The profiles or summaries assist a client in selecting an appropriate individual trainer, individual class, or training studio. For example, if a client is looking for a trainer to help them run a marathon, they can look at multiple trainer profiles and summaries to identify a person they are comfortable with for that type of training.

In some embodiments, the marketplace is integrated into the client app for clients to easily locate appropriate trainers, classes, and studios. Additionally, a vetting process is used to analyze individual trainers for the marketplace to be sure their training background and experience meets a minimum threshold to ensure the quality of the marketplace. Similar vetting processes are used for vetting individual classes, training studios, and the like. In some embodiments, clients can review personal trainers, classes, and training studios periodically. For example, clients may be required to complete a minimum number of training sessions or classes (e.g., 10 training sessions or 10 classes) before being allowed to provide a review to ensure that reviews are based on significant interaction with the trainer or class. In some implementations, clients can provide additional reviews after each additional 10 training sessions or 10 classes. The client management system may automatically send reminders to clients to submit a review after every 10 training sessions or every 10 classes are completed. In some embodiments, reviews must be submitted within 24 hours of completing the 10th training session or 10th class to ensure the reviews are submitted while the experience is fresh in the client's mind. In particular implementations, reviews can be designated as public (available to everyone) or private (only available to the trainer, gym manager, and the like).

In some embodiments, the marketplace maintains a quality score associated with each individual trainer, each individual class, and each training studio. This quality score is calculated based on client reviews, client feedback (e.g., from evaluations), renewal rate, and other factors. The renewal rate for a particular trainer includes, for example, the percentage of clients who trained for X (e.g., 10) training sessions and then renewed with the trainer for another group of training sessions. In some embodiments, the renewal rate is higher if the client renews for a larger number of training sessions than were included in the previous group of training sessions (indicating a higher satisfaction with the trainer). If the quality score falls below a threshold for a particular period of time, the trainer, class, or training studio may be removed from the marketplace.

In particular embodiments, the systems and methods described herein are used with managing monthly memberships as well as memberships having multiple levels. For example, different membership levels can provide different levels of access, different services, priority registration for classes, priority scheduling with trainers, and the like.

In some situations, the described systems and methods can manage access to various door locks, storage cabinets, exercise rooms, exercise equipment, etc. associated with a gym, training studio, or other physical location. Different membership levels or different subscriptions may provide different levels of access (and different times to access) door locks, storage cabinets, exercise rooms, and the like. For example, door locks may be unlocked when an authorized client is sensed nearby the door lock at an approved time. This control of door locks can manage access to an entire gym or training studio, access to a particular exercise room within the gym or training studio, access to a storage closet to access exercise equipment, or access to other gym or training studio facilities, tools, and the like.

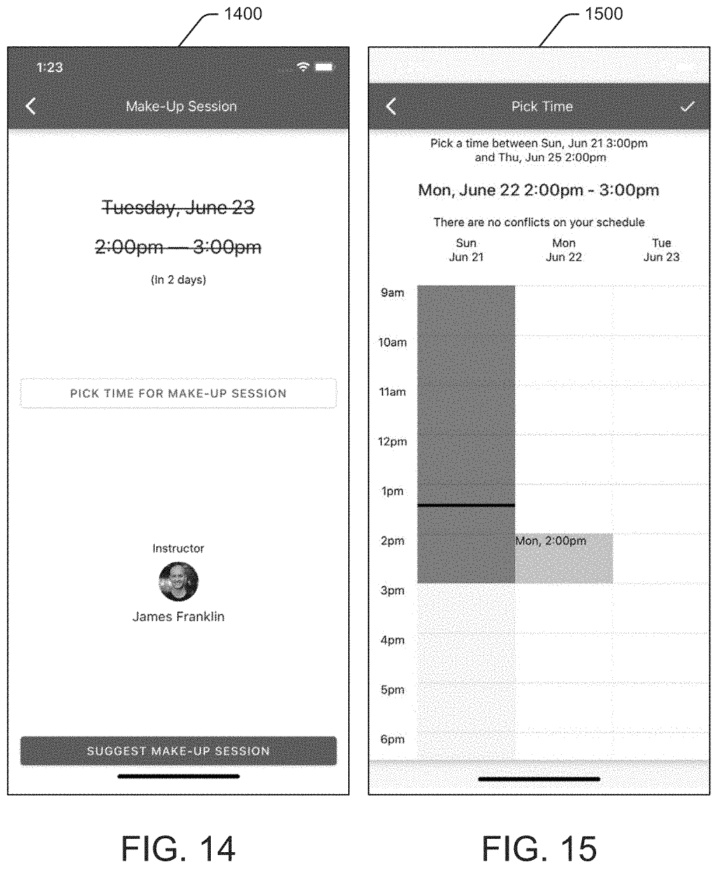

FIG. 14 illustrates an embodiment of a GUI 1400 that displays a cancelled training session and a button that allows a user to manually reschedule a training session.

FIG. 15 illustrates an embodiment of a GUI 1500 that displays a calendar with open sessions to manually reschedule a canceled training session. In some embodiments, GUI 1500 also displays existing user and/or trainer appointments on the calendar to avoid double-booking a training session.

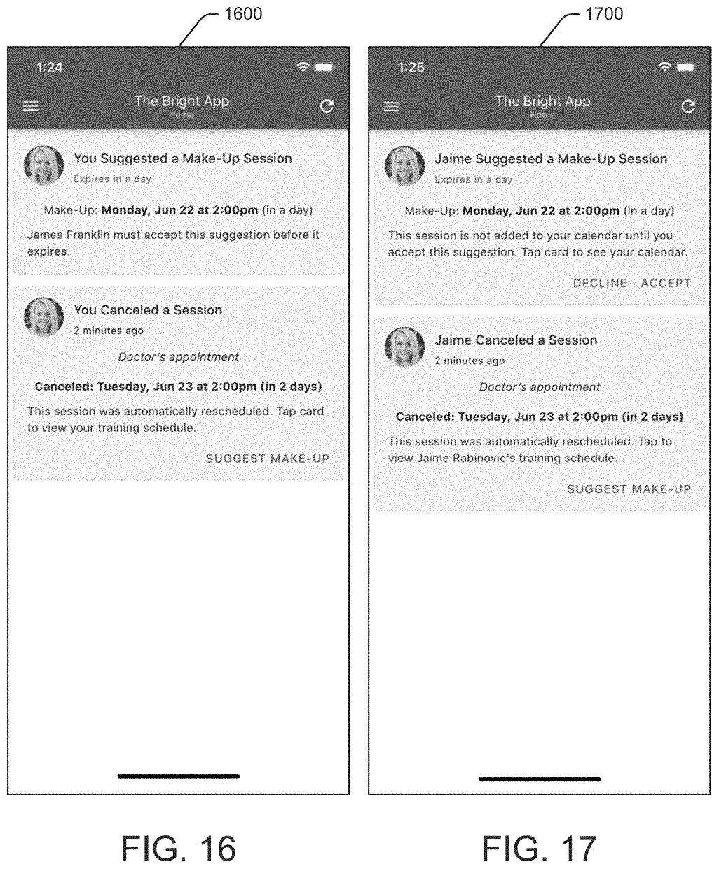

FIG. 16 illustrates an embodiment of a GUI 1600 that displays a canceled training session and a suggested make-up training session to the client.

FIG. 17 illustrates an embodiment of a GUI 1700 that displays a canceled training session and a suggested make-up training session to the trainer and provides an option for the trainer to accept or decline the suggested make-up training session.

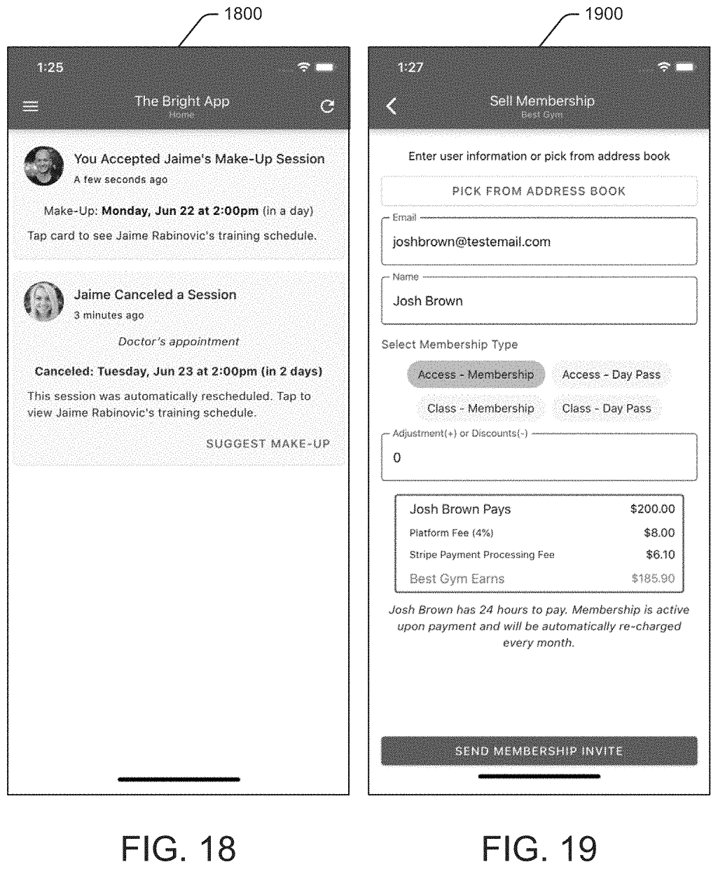

FIG. 18 illustrates an embodiment of a GUI 1800 that displays an accepted make-up training session to the trainer.

FIG. 19 illustrates an embodiment of a GUI 1900 that displays a gym membership request sent by a trainer or gym manager to a customer. As shown in GUI 1900, various types of memberships can be selected by the trainer or gym manager for offering to the customer/client. GUI 1900 also displays the pricing information and fees associated with the selected membership type.

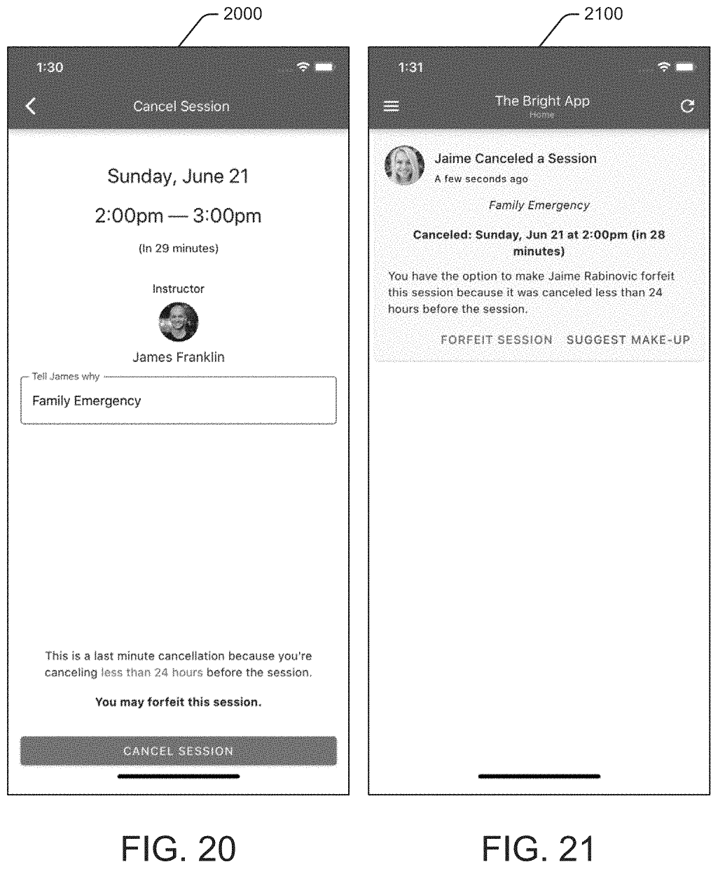

FIG. 20 illustrates an embodiment of a GUI 2000 that displays a warning to the client that they may forfeit the training session because the client is cancelling less than 24 hours before the training session.

FIG. 21 illustrates an embodiment of a GUI 2100 that displays a message to the trainer allowing the trainer to forfeit the training session or suggest a make-up training session.

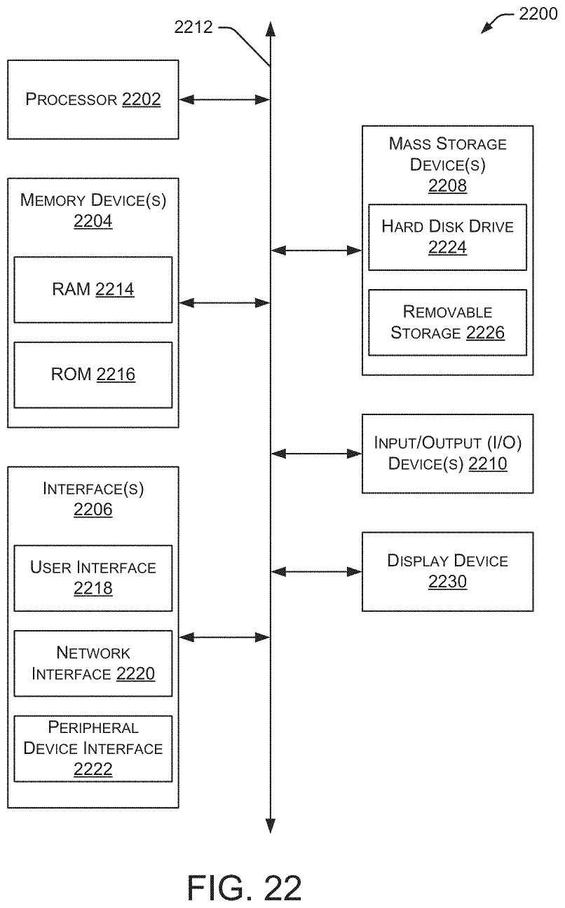

FIG. 22 illustrates an example block diagram of a computing device 2200.

Computing device 2200 may be used to perform various procedures, such as those discussed herein. For example, computing device 2200 may perform any of the functions or methods of the computing devices and systems discussed herein. Computing device 2200 can perform various functions as discussed herein, and can execute one or more application programs, such as the application programs or functionality described herein. Computing device 2200 can be any of a wide variety of computing devices, such as a desktop computer, a notebook computer, a server computer, a handheld computer, tablet computer, a wearable device, and the like.

Computing device 2200 includes one or more processor(s) 2202, one or more memory device(s) 2204, one or more interface(s) 2206, one or more mass storage device(s) 2208, one or more Input/Output (I/O) device(s) 2210, and a display device 2230 all of which are coupled to a bus 2212. Processor(s) 2202 include one or more processors or controllers that execute instructions stored in memory device(s) 2204 and/or mass storage device(s) 2208. Processor(s) 2202 may also include various types of computer-readable media, such as cache memory.

Memory device(s) 2204 include various computer-readable media, such as volatile memory (e.g., random access memory (RAM) 2214) and/or nonvolatile memory (e.g., read-only memory (ROM) 2216). Memory device(s) 2204 may also include rewritable ROM, such as Flash memory.

Mass storage device(s) 2208 include various computer readable media, such as magnetic tapes, magnetic disks, optical disks, solid-state memory (e.g., Flash memory), and so forth. As shown in FIG. 22, a particular mass storage device is a hard disk drive 2224. Various drives may also be included in mass storage device(s) 2208 to enable reading from and/or writing to the various computer readable media. Mass storage device(s) 2208 include removable media 2226 and/or non-removable media.

I/O device(s) 2210 include various devices that allow data and/or other information to be input to or retrieved from computing device 2200. Example I/O device(s) 2210 include cursor control devices, keyboards, keypads, microphones, monitors or other display devices, speakers, printers, network interface cards, modems, and the like.

Display device 2230 includes any type of device capable of displaying information to one or more users of computing device 2200. Examples of display device 2230 include a monitor, display terminal, video projection device, and the like.

Interface(s) 2206 include various interfaces that allow computing device 2200 to interact with other systems, devices, or computing environments. Example interface(s) 2206 may include any number of different network interfaces 2220, such as interfaces to local area networks (LANs), wide area networks (WANs), wireless networks, and the Internet. Other interface(s) include user interface 2218 and peripheral device interface 2222. The interface(s) 2206 may also include one or more user interface elements 2218. The interface(s) 2206 may also include one or more peripheral interfaces such as interfaces for printers, pointing devices (mice, track pad, or any suitable user interface now known to those of ordinary skill in the field, or later discovered), keyboards, and the like.

Bus 2212 allows processor(s) 2202, memory device(s) 2204, interface(s) 2206, mass storage device(s) 2208, and I/O device(s) 2210 to communicate with one another, as well as other devices or components coupled to bus 2212. Bus 2212 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 2200, and are executed by processor(s) 2202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method of rescheduling a training session, the method comprising:
identifying a client of a trainer;
determining, by a client management system, a scheduling rule associated with the client, wherein the scheduling rule defines a regular schedule for the client's training sessions with the trainer;
receiving, from the client, a request to cancel a training session previously scheduled with the trainer;
canceling, by the client management system, the previously scheduled training session; and
calculating, by the client management system, a new training session date and time based on the scheduling rule.

2. The method of claim 1, further comprising determining, by the client management system, a number of unused training sessions in the client's current package of training sessions.

3. The method of claim 2, further comprising automatically notifying, by the client management system, the client when a predetermined number of unused training sessions remain and offering the client an option to purchase another package of training sessions.

4. The method of claim 3, further comprising automatically scheduling, by the client management system, the new package of training sessions after purchase by the client, wherein scheduling the new package of training sessions is based on the scheduling rule.

5. The method of claim 1, further comprising obtaining, by the client management system, a signed waiver from the client before any training sessions are scheduled.

6. The method of claim 1, further comprising notifying the client of forfeiture of a training session if canceled within 24 hours of a session start time.

7. The method of claim 1, further comprising granting, by a door/lock controller, access to a physical training location based on a scheduled training session.

8. An method comprising:
identifying a client of a trainer;
determining, by a client management system, a scheduling rule associated with the client, wherein the scheduling rule defines a regular schedule for the client's training sessions with the trainer;
determining, by the client management system, a number of training sessions remaining in a package purchased by the client; and
automatically notifying, by the client management system, the client when a predetermined number of training sessions remain unused and offering the client an option to purchase another package of training sessions.

9. The method of claim 8, further comprising rescheduling, by the client management system, a training session by canceling the training session and calculating a new training session date and time based on the scheduling rule, wherein the scheduling rule defines a regular schedule for the client's training sessions with the trainer.

10. The method of claim 9, further comprising automatically scheduling the new package of training sessions based on the scheduling rule after the client completes payment of the new package.

11. The method of claim 9, further comprising automatically notifying the client and the trainer regarding the new training session.

12. The method of claim 9, further comprising:
notifying the trainer if the training session is canceled within a predetermined time of the session start time; and
requesting the trainer to indicate whether the client forfeits the training session.

13. The method of claim 12, wherein the predetermined time is 24 hours.

14. An apparatus comprising:
a processor configured to identify a client of a trainer;
a scheduling module configured to:
determine a scheduling rule associated with the client, wherein the scheduling rule defines a regular schedule for the client's training sessions with the trainer;
receive a request to cancel a training session scheduled with the trainer; and
reschedule the training session by canceling the training session and scheduling a new training session based on the scheduling rule.

15. The apparatus of claim 14, further comprising a communication manager configured to notify the client and the trainer regarding the new training session.

16. The apparatus of claim 14, further comprising a session tracking module configured to determine a number of unused training sessions in the client's current package of training sessions.

17. The apparatus of claim 16, further comprising a communication manager configured to:
notify the client when a predetermined number of unused training sessions remain; and
offer the client an option to purchase another package of training sessions.

18. The apparatus of claim 17, wherein the scheduling module is further configured to automatically schedule the new package of training sessions based on the scheduling rule.

19. The apparatus of claim 14, further comprising a communication manager configured to notify the client of forfeiture of a training session if canceled within a predetermined time of the session start time.

20. The apparatus of claim 14, further comprising a door/lock controller configured to grant access to a physical training location based on a scheduled training session.
